(19) United States
(12) Patent Application Publication
(10) Pub. No.: US 2018/0352009 A1
(43) Pub. Date: Dec. 6, 2018

(54) APPARATUS FOR SETTING UP CONFERENCE CALL AND METHOD THEREOF

(71) Applicant: NANNING FUGUI PRECISION INDUSTRIAL CO., LTD., Nanning (CN)

(72) Inventors: TSUNG-YUAN HUANG, New Taipei (TW); MING-CHEN TSAI, New Taipei (TW); I-HSUAN TSAI, New Taipei (TW)

(21) Appl. No.: 15/640,589

(22) Filed: Jul. 3, 2017

(30) Foreign Application Priority Data
May 31, 2017 (CN) 201710396374.3

(51) Int. Cl. H04L 29/06; H04M 7/00

(52) U.S. Cl. CPC H04L 65/1069; H04M 7/006; H04L 65/1006; H04L 65/403

(57) ABSTRACT

An apparatus to set up a conference call and method thereof, the method comprising the steps of setting up a conference call with a remote endpoint and adding at least one local endpoint to the conference call according to a preset invitation mode. Current remaining DSP resources of the apparatus are acquired, together with all the local endpoints that have joined the conference call. When a new local endpoint requires to join the conference call, an available local endpoint is screened for having the greatest remaining DSP resources of all the local endpoints. Finally, the new local endpoint can set up a connection using the available local endpoint which has the greatest DSP resources.

### FIELD

The subject matter herein generally relates to network communications, in particular to an apparatus to set up a conference call.

### BACKGROUND

Users often use Voice over Internet Protocol (VOIP) terminals for teleconferencing. Existing conference call setup include: active participation, that is, all participations dial a unified number to join a conference call; and passive join, that is already joined participation, call to other participation, so that other participants can join the same conference call. However, in the existing way, where there is a sudden or urgent conference call, it is need to inform all the participants to dial in, or to invite all the participants one by one. As a result, the existing way usually takes a lot of time to setup the conference call.

### BRIEF DESCRIPTION OF THE DRAWINGS

Implementations of the present technology will now be described, by way of example only, with reference to the attached figures, wherein:

FIG. 1 is a block diagram of one embodiment of an apparatus for setting up a conference call.

FIG. 2 illustrates a flowchart of one embodiment of a method for setting up conference call.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

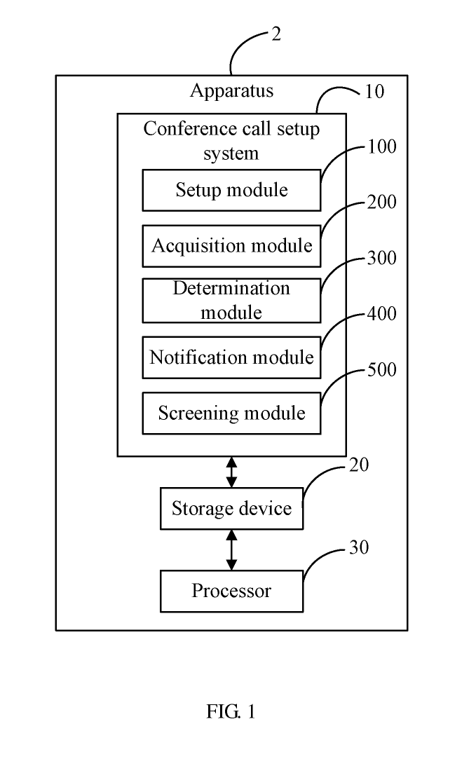

FIG. 1 illustrates an apparatus 2 in accordance with one embodiment. The apparatus 2 comprises a conference call setup system 10, a storage device 20, and a processor 30. The apparatus 2 registers with a conference manager for setting up a conference between a local end and a remote end with reference to different LAN endpoints. The apparatus 2 may be any apparatus or application endpoint that can provide voice service such as VOIP endpoints, thus VOIP gateways, mobile phones, etc.

The processor 30 may be a central processing unit (CPU), a controller, a microcontroller, a microprocessor, or a data processing chip.

The conference call setup system 10 comprises a setup module 100, an acquisition module 200, a determination module 300, a notification module 400, and a screening module 500. The modules are configured to be executed by one processors (the processor 30 in the embodiment) or more than one processor. The storage device 20 is used to store data such as program code of the conference call setup system 10, and the processor 30 is used to execute the program code stored in the storage device 20.

The setup module 100 sets up a conference call with a remote endpoint and adds at least one local endpoint to the conference call according to a preset invitation mode.

More specifically, the invitation mode includes an active mode and a passive mode. The active mode is when the apparatus 2 actively invites the local endpoints to join the conference call. The passive mode is a request being received by the apparatus 2 that is sent by the local endpoints to join the conference call. The local endpoints may be any apparatus or application endpoint that can provide voice services and each local endpoint is not limited to being the same type.

When the preset invitation mode is the active mode, the setup module 100 sends an ID of the conference call to all the local endpoints, inviting all the local endpoints to join the conference call (group invitation). Each of the local endpoints determines whether or not to join the conference call, and then transmits a response to the apparatus 2. When the setup module 100 receives a positive response from the local endpoint, to join the conference call, the setup module 100 sets up a connection with the local endpoint. In one embodiment, the setup module 100 transmits an IP address of the apparatus 2 to the local endpoint that wishes to join, and notifies the local endpoint to setup a connection with the apparatus 2.

In another embodiment, the setup module 100 sends a lookup notification to all the local endpoints before inviting the local endpoints to join the conference call, to determine whether the ID of the conference call is being used on a local LAN. When each local endpoint receives the lookup notification, it returns a search result to the apparatus 2, and the search result includes an indication as to whether or not the ID of the conference call has been used. When the ID of the conference call has been used, the setup module 100 replaces an old ID and allocates a new ID for the conference call.

When the present invitation mode is the passive mode, the setup module 100 receives a request containing the ID of the conference call sent from the local endpoints, and then sets up a connection with the requesting one. In one embodiment, the local endpoints may send a request to join the conference call by dialing a call ID.

In addition, each of the local endpoints may configure a conference call ID to be monitored in advance, and when the invitation or the notification including the conference call is received, the response agreeing to join the conference call or the request to join the conference call is automatically transmitted.

The acquisition module 200 acquires current remaining digital signal processing (DSP) resources of the apparatus 2 and information as to all the local endpoints that have joined the conference call.

More specifically, the acquisition module 200 acquires its own resource status, and notifies the local endpoints that have joined the conference call to provide resource status information including current remaining DSP resources and the IP address. The acquisition module 200 then receives resource status information fed back by the local endpoints that have joined the conference call. The acquisition module 200 records all the local endpoints that have joined the conference call and the resource status information of each local endpoint.

The determination module 300 determines whether current remaining DSP resources of the apparatus 2 are sufficient when a new local endpoint requires to join the conference call. In one embodiment, such sufficiency means that current remaining DSP resources of the apparatus 2 can also satisfy communication requirements of the new local endpoint requiring to join the conference call.

The notification module 400 notifies the new local endpoint to set up a connection with the apparatus 2 when current remaining DSP resources of the apparatus 2 are sufficient.

The screening module 500 filters out an available local endpoint based on the remaining DSP resources of the local endpoints that have joined the conference call when current remaining DSP resources of the apparatus 2 are insufficient.

In one embodiment, the screening module 500 sorts the remaining DSP resources of the local endpoints that have joined the conference call and then determines the local endpoint with the largest remaining DSP resources as the available local endpoint. The available local endpoint mixes and forwards communication data for the new local endpoint so that the new local endpoint can join the conference call by connecting to the available local endpoint.

The notification module 400 notifies the new local endpoint to set up a connection with the available local endpoint.

More specifically, the notification module 400 searches for an IP address corresponding to the available local endpoint from previously received resource status information, and then sends the IP address corresponding to the available local endpoint to the new local endpoint to notify the new local endpoint to set up the connection with the available local endpoint, and receives a response as to connection result.

Further, the setup module 100 further receives updated connection status from the local endpoints that have joined the conference call at predetermined intervals, including success of the connection, failure of the connection, connection interruption, and so on. The setup module 100 may adjust the connection endpoint according to the received connection status. For example, when the connection status of the new local endpoint which corresponds to the available local endpoint is a connection failure, the setup module 100 selects a local endpoint which has second-largest remaining DSP resources as the available local endpoint and notifies the new local endpoint to re-set up a connection with the second-largest available local endpoint.

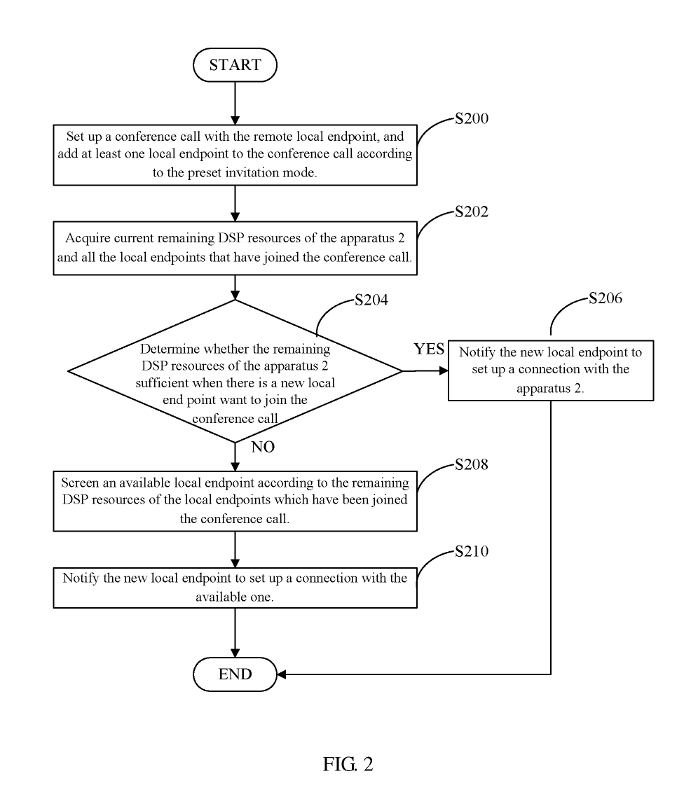

FIG. 2 illustrates a flowchart of a conference call setup method, in accordance with one embodiment. The conference call setup method is applied to the apparatus 2, and is implemented by the program code stored in the storage device 20 which is executed by the processor 3.

In step S200, sets up a conference call with the remote local endpoint, and add at least one local endpoint to the conference call according to the preset invitation mode.

In step S202, acquires current remaining DSP resources of the apparatus 2 and all the local endpoints that have joined the conference call.

In step S204, determines whether the remaining DSP resources of the apparatus 2 sufficient when there is a new local end point want to join the conference call. If the remaining DSP resources of the apparatus 2 are sufficient, step S206 is executed; otherwise, steps S208-210 are executed.

In step S206, notifies the new local endpoint to set up a connection with the apparatus 2.

In step S208, screens an available local endpoint according to the remaining DSP resources of the local endpoints which have been joined the conference call.

In step S210, notifies the new local endpoint to set up a connection with the available endpoint.

It is to be noted that, in the embodiment, between the apparatus 2 and any one of the local endpoints, and between any two of the local endpoints, a peer-to-peer (P2P), rather than using a standard signaling protocol, such as Session Initiation Protocol (SIP), to communicate.

The local endpoints in the same conference call do not need to register to the same conference manager or even need to register to the conference manager. The local endpoints simply connected to the designated available local endpoint and achieve the conference call.

In one embodiment, a set of private packets can be defined in advance, and then all the notifications, invitations and response messages in the above description are sent using the private packets. The private packets comprising:

Discovery packet: sent by the apparatus 2, containing the ID of the conference call, for discovering whether the ID of the conference call has been used in the local LAN.

Duplicate packet: sent by the local endpoints to respond to the Discover packet and notify the apparatus 2 that the ID of the conference call has been used.

Invite packet: sent by the apparatus 2, containing the ID of the conference call for inviting the local endpoints to join the conference call.

Join packet: sent by the local endpoint intended to join the conference call for responding to the Invite packet in the active mode, sending response information agreed to join the conference call to the apparatus 2. In the passive mode, a request to join the conference call is automatically sent.

AskRTP packet: sent by the apparatus 2 to notify the local endpoint that has joined the conference call to provide its own resource status.

AckRTP packet: sent by the local endpoints that has joined the conference call for responding to the AskRTP packet and to the apparatus 2 to the resource status information including the current remaining DSP resources and the IP address.

Adopt packet: sent by the apparatus 2 for responding to the Join packet, including the IP address corresponding to the available local endpoint, notifying the new local endpoint intended to join the conference call to set up a connection with the available local endpoint.

Update packet: send by the local endpoint that has joined to the conference call periodically every predetermined time period, including the connection status information updated by the local endpoint.

The embodiments shown and described above are only examples. Many details are often found in the art such as the other features of a docking apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for setup a conference call using an apparatus, the method comprising steps of:
setting up a conference call with a remote endpoint and adding at least one local endpoint to the conference call according to a preset invitation mode;
acquiring remaining DSP resources of the apparatus and all the local points that have joined the conference call;
determining whether the remaining DSP resources of the apparatus are sufficient when a new local endpoints requires to join the conference call;
notifying the new local endpoint to set up a connection with the apparatus when the remaining DSP resources of the apparatus are sufficient;
screening an available local endpoint based on the remaining DSP resources of all the local endpoints, and
notifying the new local endpoint to set up a connection with the available local endpoint when the remaining DSP resources of the apparatus are insufficient.

2. The method of claim 1, wherein the step of adding at least one local endpoint to the conference call comprises:
sending a ID of the conference call to all the local endpoints when the preset invitation mode is an active mode, inviting all the local endpoints to join the conference call;
receiving response information sent by the local endpoint to join the conference call; and
setting up a connection with the local endpoint.

3. The method of claim 2, wherein the step of adding at least one local endpoint to the conference call further comprises:
receiving a request to join the conference call automatically sent by the local endpoint when the preset invitation mode is a passive mode, the request containing the ID of the conference call; and
setting up a connection with the local endpoint.

4. The method of claim 3, further comprising the steps of: prior to the step of inviting all the local endpoints to join the conference call:
sending a lookup notification to all the local endpoints to find out whether the ID of the conference call has been used by other conference calls in a local LAN;
receiving a search result fed back by the local endpoints, the search result including whether the ID of the conference call has been used or not; and
replacing a new ID for the conference call when the ID of the conference call has been used.

5. The method of claim 1, wherein the step of acquiring the remaining DSP resources of all the local endpoints that have joined the conference call comprises:
notifying all the local endpoints that have joined the conference call to provide resource status information including remaining DSP resources and an IP address of its own; and
receiving resource status information fed back by the local endpoints.

6. The method of claim 5, wherein the step of screening an available local endpoint according to the remaining DSP resources of all the local endpoints comprises:
sorting the remaining DSP resources of the local endpoints that have joined the conference call;
screening one local endpoint that having the largest remaining DSP resources; and
determining the local endpoint having the largest remaining DSP resources as the available local endpoint.

7. The method of claim 5, wherein the step of notifying the new local endpoint to set up a connection with the available local endpoint comprises:
searching the IP address correspond to the available local endpoint;
sending the IP address corresponding to the available local endpoint to the new local endpoint;
notifying the new local endpoint to set up a connection with the available local endpoint; and
receiving a result of the connection sent from the new local endpoint.

8. The method of claim 1, further comprising:
receiving connection status information updated periodically by the local endpoints that have joined the conference call every predetermined time period, wherein the connection status information including connection success, connection failure, and connection interruption.

9. A apparatus comprising:
a processor;
a storage device storing instructions, wherein the instructions are executed on the processor to cause the processor to perform a method for setup a conference call, the method comprising;
setting up a conference call with a remote endpoint and adding at least one local endpoint to the conference call according to a preset invitation mode;
acquiring remaining DSP resources of the apparatus and all the local points that have joined the conference call;
determining whether the remaining DSP resources of the apparatus are sufficient;
notifying the new local endpoint to set up a connection with the apparatus when the remaining DSP resources of the apparatus are sufficient;
screening an available local endpoint based on the remaining DSP resources of all the local endpoints, and
notifying the new local endpoint to set up a connection with the available local endpoint when the remaining DSP resources of the apparatus are insufficient.

10. The apparatus of claim 9, wherein the step of adding at least one local endpoint to the conference call comprises:
sending a ID of the conference call to all the local endpoints when the preset invitation mode is an active mode, inviting all the local endpoints to join the conference call;
receiving response information sent by the local endpoint to join the conference call; and
setting up a connection with the local endpoint.

11. The apparatus of claim 10, wherein the step of adding at least one local endpoint to the conference call further comprises:
receiving a request to join the conference call automatically sent by the local endpoint when the preset invitation mode is a passive mode, the request containing the ID of the conference call; and
setting up a connection with the local endpoint.

12. The apparatus of claim 11, wherein the method further comprising the steps of: prior to the step of inviting all the local endpoints to join the conference call:
sending a lookup notification to all the local endpoints to find out whether the ID of the conference call has been used by other conference calls in a local LAN;
receiving a search result fed back by the local endpoints, the search result including whether the ID of the conference call has been used or not; and
replacing a new ID for the conference call when the ID of the conference call has been used.

13. The apparatus of claim 9, wherein the step of acquiring the remaining DSP resources of all the local endpoints that have joined the conference call comprises:
notifying all the local endpoints that have joined the conference call to provide resource status information including remaining DSP resources and an IP address of its own; and
receiving resource status information fed back by the local endpoints.

14. The apparatus of claim 13, wherein the step of screening an available local endpoint according to the remaining DSP resources of all the local endpoints comprises:
sorting the remaining DSP resources of the local endpoints that have joined the conference call;
screening one local endpoint that having the largest remaining DSP resources; and
determining the local endpoint having the largest remaining DSP resources as the available local endpoint.

15. The apparatus of claim 13, wherein the step of notifying the new local endpoint to set up a connection with the available local endpoint comprises:
searching the IP address correspond to the available local endpoint;
sending the IP address corresponding to the available local endpoint to the new local endpoint;
notifying the new local endpoint to set up a connection with the available local endpoint; and
receiving a result of the connection sent from the new local endpoint.

16. The apparatus of claim 9, wherein the method further comprising:
receiving connection status information updated periodically by the local endpoints that have joined the conference call every predetermined time period, wherein the connection status information including connection success, connection failure, and connection interruption.
